(19) United States
(12) Patent Application Publication
(10) Pub. No.: US 2026/0311178 A1
(43) Pub. Date: Oct. 8, 2026

(54) LOW FRICTION BANK SELECTION AND CHECKOUT METHOD

(71) Applicant: Capital One Services, LLC, McLean, VA (US)

(72) Inventors: Jeffrey RULE, Chevy Chase, MD (US); Jackson MACOMBER, Henrico, VA (US); Nicole PARFITT, Annandale, VA (US); Adam MAAREC, Potomac, MD (US); Lawrence DOUGLAS, McLean, VA (US); Paul Y. MORETON, Tuscaloosa, AL (US); Bob Uni KOSHY, Henrico, VA (US)

(73) Assignee: Capital One Services, LLC, McLean, VA (US)

(21) Appl. No.: 19/543,418

(22) Filed: Feb. 18, 2026

Related U.S. Application Data
(63) Continuation of application No. 18/285,312, filed on Apr. 1, 2022, now abandoned.

(30) Foreign Application Priority Data
Apr. 1, 2021 (SG) 10202103350V

(51) Int. Cl. G06Q 20/40; G06Q 20/38

(52) U.S. Cl. CPC G06Q 20/4012; G06Q 20/385; G06Q 20/386

(57) ABSTRACT

Provided herein are systems and methods for providing low-friction layered authentication to provide account information with a single user pin input for an online payment transaction. A user provides an online payment service with a UID, which sends the UID to a financial institution. The financial institution verifies whether the user and online payment transaction associated with the UID satisfy a set of rules. A one-time pin is sent to provide an additional layer of authentication. Once the authentication is complete, the financial institution provides account information to the online payment service for use in the online payment transaction.

### CROSS REFERENCE TO OTHER APPLICATIONS

This application is a continuation of U.S. patent application Ser. No. 18/285,312, filed on Oct. 2, 2023, which is a national stage patent application under 35 U.S.C. § 371 claiming priority to PCT Application No. PCT/US 2022/023066, filed on Apr. 1, 2022, and claims priority to Singapore Patent Application No. 10202103350V filed Apr. 1, 2021, which are hereby incorporated by reference in their entirety.

### BACKGROUND

Consumers commonly purchase goods and services online. To conduct these online transactions, a merchant will generally provide a web interface, or sometimes a mobile application, that allows a consumer to select the good or service that she would like to purchase and to consummate the transaction. Usually, these online transactions are paid for by a credit card. When a consumer uses a credit card, information describing the transaction is communicated to a financial services provider (such as a bank or other financial institution) issuing the credit card, which debits the amount paid from a credit line issued to the consumer and credits amount paid to the merchant.

Instead of communicating transaction information directly to a financial institution, online merchants will frequently use online payment processors. Online payment processors or services allow consumers to make purchases online through online money transfers. In some cases, a virtual wallet is provided that allows a consumer to manage and select accounts for use in online payments. Some examples of online payment processors are PayPal® or Stripe®.

To protect user account information, complex authentication procedures have been implemented by online merchants, online payment services, and financial institutions. For example, financial institutions typically require two-factor authentication for a consumer to access any of her account information. For example, the consumer logs in using a user name and password for the financial institution as a first authentication factor. The financial institution determines that the consumer satisfies the first authentication factor and then performs a second authentication factor, such as sending the consumer an email containing a one-time use pin. The one-time pin is generated uniquely for an authentication and is not used again. The financial institution sends the email to the consumer's on-file email address. As a result, the person logging in should only have access to the email if the person is also the relevant consumer. These authentication procedures help to ensure that the person accessing her account information is actually the relevant consumer.

While conventionally believed to be important for security, complex authentication procedures make the user experience less enjoyable. For example, a user often has to remember many passwords and user names. This can be frustrating. However, existing systems require the entry of this information to provide sufficient user protection, including fraud protection.

Methods and systems are needed to allow access to account information in a secure, but less, frustrating manner.

### BRIEF SUMMARY

Disclosed herein are systems, methods and computer program products for low-friction layered authentication to provide account information with a single user password input.

In an embodiment, a unique identifier for a user is received from an online payment service. The receipt occurs at a processor (e.g., a computer processor, such as processor 404 described below in relation to FIG. 4), such as a processor provided by a financial institution. The processor applies a set of rules to account information for accounts at the financial institution that are associated with the user. When satisfied, the set of rules increase confidence that an individual who submitted the unique identifier to the online payment service is the user of an account at the financial institution. When the processor determines that the account information of the user satisfies the set of rules, the processor sends a response that the user has the accounts to the online payment service. The processor also sends a one-time pin to a user device and determines whether a pin input in the online payment service matches the one-time pin. When the pin input is determined to match the one-time pin, the processor sends the online payment service account information for one of the user's accounts for use in completing the online payment transaction.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the art(s) to make and use the embodiments.

FIG. 1 illustrates a block diagram of a system that allows an online payment provider to retrieve account information in a low friction manner, according to some embodiments.

FIG. 2 is a flowchart illustrating a method for authenticating a user and completing an online purchase, according to some embodiments.

FIGS. 3A, 3B, and 3C illustrate example depictions of a device screen at various points in the methods described herein, according to some embodiments.

FIG. 4 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for low-friction layered authentication to provide account information with a single user password input.

The methods and systems described herein provide layered authentication that lowers the friction a user experiences. For example, in some embodiments, the authentication is performed in real-time during user checkout, reducing the delay experienced by the user. The real-time authentication may occur in the background while the user is performing other checkout steps, such as entering an email address. In some embodiments, the user has to enter less information. In some embodiments, the user does not have to remember a password for authentication while still providing layered security.

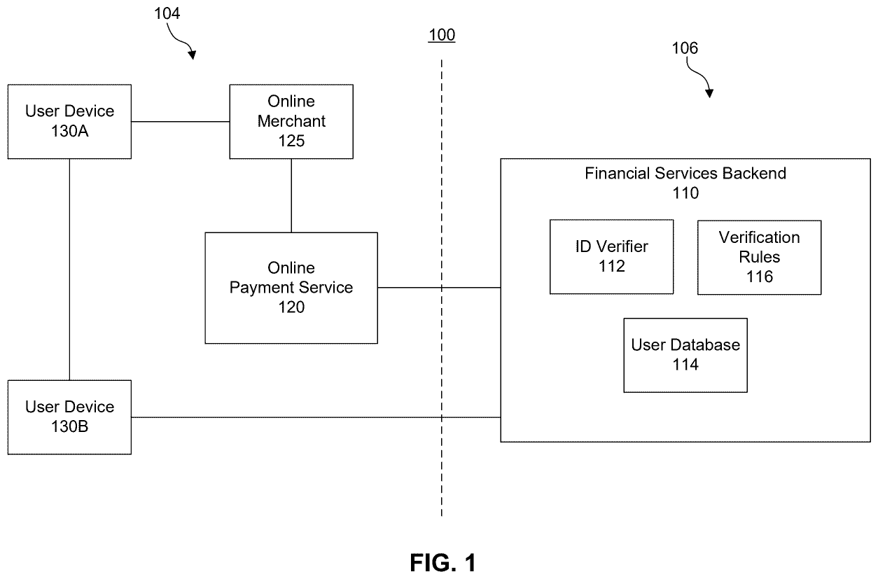

FIG. 1 illustrates a block diagram of a system 100, according to some embodiments. System 100 is divided into two portions by the dotted line: purchaser side 104 and financial institution side 106. Purchaser side 104 is a side where a user makes online purchases. As part of making an online payment, purchaser side 104 communicates with financial institution side 106, which is responsible for authenticating a user and providing information to complete a payment, such as an account number or card expiration date. Purchaser side 104 and financial institution side 106 are connected through the internet or one or more networks.

Purchaser side 104 has a user device 130A connected to online merchant 125 and online payment service 120. User device 130A is a computer, tablet, mobile device, laptop, smart phone, or other internet-capable device. In some embodiments, purchaser side 104 also has user device 130B, which is a smart phone or other internet-or wireless-capable device. Online payment service 120 and user device 130B are connected to financial institution side 106.

User device 130A accesses, via a network or the internet, online merchant 125. Online merchant 125 is a seller of goods or services through the internet and provides a website from which a user of user device 130A selects goods or services for purchase. To allow the user to pay for the goods, online merchant 125 connects to online payment service 120. In some embodiments, online payment service 120 is a go-between between online merchant 125 and financial services backend 110. In some embodiments, online payment service 120 is a virtual wallet or other virtual or online service that securely maintains user account information for making online purchases.

When a user proceeds to checkout while accessing online merchant 125 on user device 130A, the user interfaces with online payment service 120. In some embodiments, online payment service 120 is a part of the website provided by online merchant 125, a separate website or application controlled by online payment service 120 that is integrated into or connected to the website provided by online merchant 125, or a separate website or application that user device 130A accesses when attempting to make a payment to online merchant 125.

Online payment service 120 communicates with financial services backend 110 to authenticate the user and obtain information about the user's account for making a payment from the user to online merchant 125. In some embodiments, online payment service 120 generates and verify a one-time pin as part of user authentication.

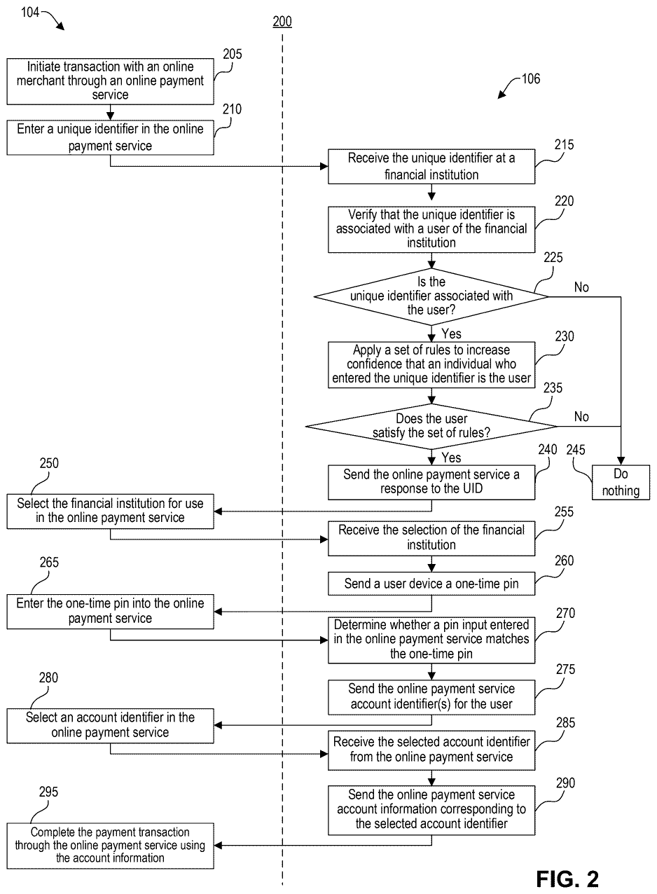

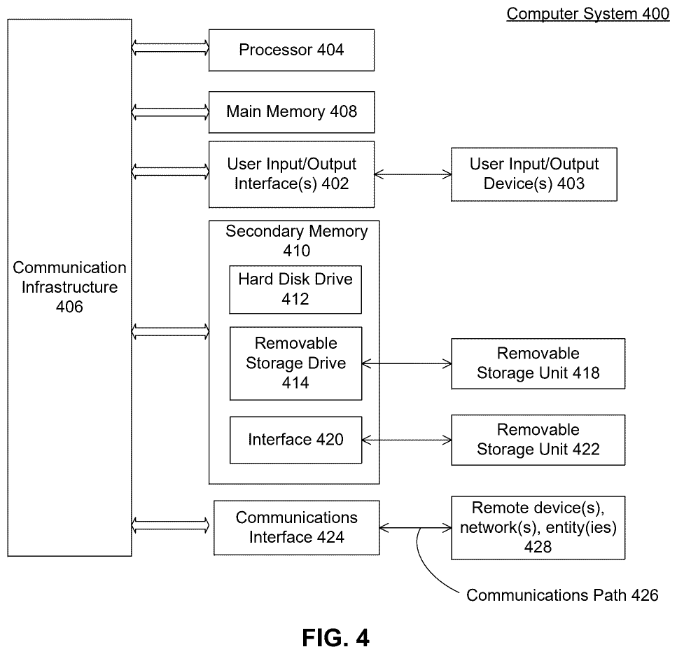

Financial institution side 106 has financial services backend 110. Financial services backend 110 has an identification (ID) verifier 112, a user database 114, and verification rules 116. In some embodiments, the financial institution associated with financial institution side 106 and financial services backend 110 is a bank. Financial services backend 110 is a server, is hosted on a server, or is a computer or computer system, such as computer system 400, described below in relation to FIG. 4. In some embodiments, financial services backend 110 performs operations, such as those required by method 200 described in regards to FIG. 2 below, in real time.

ID verifier 112 identifies and verifies the user of an account, as well as authenticating to determine whether to allow user device 130A access to the account. ID verifier 112 communicates with user database 114 and verification rules 116. ID verifier 112 sends a one-time pin to user device 130B for use in authentication. In some embodiments, the one-time pin is a text string, such as a six-digit number, that expires in a short window of time, such as after twenty or thirty minutes. ID verifier 112 or online payment service 120 generate the one-time pin when it is needed and monitor the window of time.

In some embodiments, ID verifier 112 sends the one-time pin via a short messaging service (SMS) message or text. In some embodiments, the SMS message automatically populates the one-time pin from the SMS message into a pin entry form provided by online payment service 120.

In some embodiments, a user accesses online merchant 125 via user device 130A that is the same user device 130B to which ID verifier 112 sends the SMS message. In such embodiments, user device 130A and user device 130B are the same device. In such embodiments, user device 130A and user device 130B are a smart phone or other internet-or wireless-capable device. In such embodiments, user device 130A and user device 130B are referred to collectively as user device 130.

User database 114 stores account information about a user and the user's accounts. For example, user database stores account information that includes the user's name, unique identifier (UID), account number(s), account balance, whether the user has consented to receive short message service (SMS) messages on a mobile phone, mobile phone number, billing address, shipping address, card verification value (CVV), email address, one or more virtual card or account numbers, online merchants and/or payment providers associated with the one or more virtual account numbers, and device IDs of devices that the user has used to make online transactions previously.

Verification rules 116 stores a set of rules for verifying or authenticating a user or an account for use in online purchases. In some embodiments, the set of rules includes rules for checking account information in user database 114. For example, rules for checking account information in user database 114 include whether a user account is eligible or enabled for online payment, whether there is sufficient balance in the account for the payment transaction, whether the user has a stable mobile phone number (e.g., checking with a mobile network operator (MNO) to see if the phone number is stable), whether the mobile phone number may be sent SMS messages, whether the user has consented to third-party data sharing, whether the user or the transaction present any fraud risks, and whether the user or the transaction trip any security flags. In some embodiments, checking whether a user has stable mobile phone number includes contacting the user's MNO to see if the user has recently made changes to their account, such as number porting.

In some embodiments, the set of rules include fraud prevention rules that determine whether the user or the transaction present any fraud risks. In some embodiments, fraud prevention rules use account information from user database 114 and information provided from user device 130A regarding an attempted payment transaction via online payment service 120. For example, fraud prevention rules include checking whether the user device is operating with a location code that is within a predefined area for the user's accounts, whether user device 130A has a device ID that has not been seen before, whether the SIM ID of user device 130A has a mismatch with the device ID of user device 130A, and whether the IP address or MAC address of user device 130D matches user device 130A, the location of user device 130A, or previously seen IP addresses or MAC addresses used by the user.

In some embodiments, ID verifier 112 receives information, such as a UID from a user via online payment service 120. ID verifier 112 determines whether the UID is associated with account information stored in user database 114. ID verifier determines whether the account information stored in user database 114 and information provided by online payment service 120 regarding the attempted payment at online merchant 125 satisfy some or all of the set of rules in verification rules 116.

ID verifier 112 provides online payment service 120 account information from user database 114 for making a payment. In some embodiments, ID verifier 112 sends a software tool kit (STK) or javascript message to user device 130A via online payment service 120. The STK or javascript message allows user device 130A to automatically populate the account information into a form in the website or application provided by online payment service 120.

In some embodiments, ID verifier 112 assigns a virtual account number to an account in or retrieves a virtual account number for an account from the account information for a user in user database 114. A virtual account number resembles an account number and may take the same form—e.g., in one embodiment, a 16-digit number with an associated 3-digit CVV and an expiration date. A virtual account number may serve the same function as an account number in that a customer may provide the virtual account number and a CVV to a merchant and incur an expense against their credit account. In this fashion, the virtual account number serves as a proxy for the account number. In some embodiments, the virtual account number has the same last four digits as the matching account number.

A customer or ID verifier 112 may also associate the virtual account number with a particular merchant and specify merchant-specific controls. For example, a customer may specify a spending cap or other restrictions on the virtual account number that afford additional security checks. Subsequent transactions perform merchant-binding to ensure that the appropriate merchant is processing the transaction and that the merchant-specific controls are satisfied.

In some embodiments, the virtual account number is uniquely associated with online payment service 120, but not the physical account number printed on the user's credit card. ID verifier 112 updates the account information in user database 114 to indicate that the account is associated with the virtual account number and online payment service 120.

FIG. 2 is a flowchart illustrating a method 200 for authenticating a user and completing an online purchase, according to some embodiments. Method 200 provides a low-friction layered authentication that provides account information while requiring a single user pin input. Method 200 has purchaser side 104 and financial institution side 106 with the dotted line dividing the two sides. Operations of method 200 are shown on purchaser side 104 or financial institution side 106 to indicate that the corresponding side of system 100 performs those operations. Generally, operations are performed on either provider side 104 or financial institution side 106. In some embodiments, some operations of method 200 are performed on either or both of the sides. Such details are included in the description of the individual operations below.

In 205, method 200 includes initiating a transaction with online merchant 125 through online payment service 120. A user initiates the transaction with online merchant 125 on user device 130A. In some embodiments, the user selects to use online payment service 120. In some embodiments, the online merchant 125 selects online payment service 120.

For example, the user accesses a website for online merchant 125 on user device 130A. The user selects an object to purchase and then proceeds to checkout. Online merchant 125 may have an agreement with online payment service 120 to handle payment transactions for the website. When the user proceeds to checkout, online merchant 125 links the user to a website where online payment service 120 handles the payment transaction. In some embodiments, the website for online payment service 120 is formatted or configured to appear to be part of online merchant 125's website.

In 210, method 200 includes entering a UID in online payment service 120. The user enters the UID using, for example, a keyboard or touch screen entry system on user device 130A. The user enters the UID in a field or form on the website that online payment service 120 uses to handle payment transactions. In some embodiments, the user enters the UID into a specific field for the type of UID. The UID is a user name, a user phone number, a user email address, or another identifier that is uniquely associated with the user.

In some embodiments, the website for online payment service has other fields or forms for entering account information used in making a payment, such as account number, card expiration date, CVV, user name, and other account information. Method 200 allows the user to bypass manually filling out all of this information by simply entering the UID. In some embodiments, the user enters no pin or password with the UID and online payment service 120 simply sends the UID to financial services backend 110 after the user enters the UID. In some embodiments, the user performs an action on the website, such as clicking a button, to indicate that the user has fully entered the UID.

In some embodiments, online payment service 120 sends the UID to multiple financial institutions, potentially allowing the user to access accounts at multiple financial institutions and select the desired account. In some embodiments, online payment service 120 sends the UID in a hashed format. The hashed format is configured so that financial institutions can only decode a UID that matches one of their customers. The hashed format provides additional personal security for the user and prevents other financial institutions from decoding the UIDs of users of competing financial institutions.

In some embodiments, online payment service 120 also sends transaction information about the payment transaction that the user is attempting. The transaction information may include the dollar amount of the transaction, the identity of the online payment service 120, the identity of the online merchant 125, location information for user device 130A, a sim card ID for user device 130A, a device ID for user device 130A, an IP address or MAC address for user device 130A, or other information about the transaction and user device 130A that is used to determine if the user of user device 130A is the same as a user with an account at the financial institution.

In 215, method 200 includes receiving the UID at a financial institution. The financial institution provides or has access to financial services backend 110. Financial services backend 110 receives the UID from online payment service 120 and pass the UID to ID verifier 112.

In 220, method 200 includes verifying that the UID is associated with a user of the financial institution. ID verifier 112 verifies that the UID is associated with a user of the financial institution. In the context of method 200, it should be understood that there might be two different users. The first user is the user of device 130A. The first user is the user attempting to make a payment transaction. The second user is a user associated with the UID. The first user has entered the UID but may not actually be the second user. Financial services backend 110 performs operations of method 200 to reduce uncertainty in the identity of the first user. These operations increase confidence that the first user is the second user. In some embodiments, these operations are some or all of operations 220, 225, 230, 235, 240, and 245.

Thus, in the context of operation 220, ID verifier 112 verifies that the UID is associated with a user (e.g., the second user) of the financial institution. ID verifier 112 accesses account information stored in user database 114 and compares the received UID with UIDs in the account information.

In some embodiments, operation 220 includes ID verifier 112 decoding the UID from a hashed format. In some embodiments, ID verifier 112 successfully decodes the hashed UID and can compare the UID to the account information in user database 114. In some embodiments, ID verifier 112 cannot decode the hashed UID and cannot perform a comparison. When ID verifier 112 cannot decode the hashed UID, this indicates that the hashed UID does not match the format for the financial institution and is not associated with a user of the financial institution.

In 225, method 200 queries whether the UID is associated with a user. ID verifier 112 determines that the UID is associated with a user based on the comparison made in operation 220. If one of the UIDs in the account information matches, the received UID, ID verifier 112 identifies that user as the second user. In this case, method 200 proceeds to operation 230. When operation 220 finds no match, ID verifier 112 determines that no account matches the received UID and proceeds to operation 245.

In some embodiments, when operation 220 fails to decode the hashed UID, operation 225 treats this as failing to find a user that matches the UID. In such embodiments, operation 225 proceeds to operation 245.

In 230, method 200 includes applying a set of rules to increase confidence that an individual who entered the UID is the user. In operation 230, the individual is the first user, as described above, while the user is the second user. ID verifier 112 accesses the rules from rules database 116.

In some embodiments, ID verifier 112 checks whether a rule is satisfied by determining whether account information in user database 114 for the user satisfies the rule. For example, ID verifier 112 determines whether a rule that the user (e.g., the second user) has given the financial institution permission to use account information for making online payments by checking the online payment account settings in the account information for the user in user database 114. When the user has given permission, the rule is satisfied. When the user has not given permission, the rule is not satisfied.

In some embodiments, ID verifier checks whether a rule is satisfied by determining whether account information in user database 114 and transaction information received from online payment service 120 satisfy the rule. For example, ID verifier 112 determines whether a rule that the transaction initiated by the user (e.g., the first user) on device 130A has location information that satisfies a geolocation rule for the user's (e.g., the second user) account by checking account location information in the account information for the user (e.g., the second user) in user database 114 and location information received from online payment service 120 as part of the transaction information. When the location information indicates a location within a certain distance, defined by the geolocation rule, of the account location information, the rule is satisfied. When the location information indicates a location that is not within a certain distance, defined by the geolocation rule, of the account location information, the rule is not satisfied.

In 235, method 200 queries whether the user satisfies the set of rules. ID verifier 112 determines whether the set of rules has been satisfied based on the determination(s) for each rule in operation 230.

In some embodiments, ID verifier 112 checks whether every rule in the set of rules has been satisfied. When every rule is satisfied, method 200 proceeds to operation 240. When not every rule has been satisfied, method 200 proceeds to operation 245.

In some embodiments, ID verifier 112 checks whether predetermined number of the set of rules, such as the set of rules in verification rules 116, have been satisfied. The predetermined number of rules are configured to establish or require a sufficient amount of confidence, based on the set of rules, to accept the first user as the second user, avoiding the need for the user to, for example, enter an account password or pin. When the predetermined number of rules have been satisfied, method 200 proceeds to operation 240. When the predetermined number of rules have not been satisfied, method 200 proceeds to operation 245.

In some embodiments, the predetermined number of rules are a minimum number of rules from the set of rules that must be satisfied. For example, the predetermined number of rules is five rules or half of the rules. In some embodiments, the predetermined number of rules are a required set of rules that must all be satisfied and an optional set of rules, of which a certain amount, such as half, must be satisfied. The choice of required rules selects critical rules for authenticating the user. The choice of optional rules selects rules that are desirable, or pairs or groups of rules where each rule provides similar indicators of the authenticity of the first user, so only one need be satisfied.

In still another embodiment, each rule imparts a certain degree of confidence. For example, each rule may have an associated weight that, if satisfied, it imparts to a confidence score. If the score exceeds a threshold, the ID is verified. The weights may be determined, for example, as preset policies or using machine learning techniques.

In this way, the set of rules in rules database 116 are selected and configured such that operations 230 and 235 increases the confidence that the user is in fact the individual corresponding to the UID, which is authorized to access account information needed to complete a transaction. The financial institution selects the rules to provide sufficient layers of security and authentication based on industry standards. In some embodiments, when operation 235 determines that the set of rules are satisfied, method 200 treats the first user and the second user as the same user.

In some embodiments, ID verifier 112 performs operations 230 and 235 separately for each account associated with the UID. Each account may individually satisfy (or not satisfy) the set of rules.

In some embodiments, operations 230 and 235 include more than one set of rules that are applied separately to decrease user latency. For example, a first set of rules is applied in response to operation 225 determining that the user has and account with the financial institution. The first set of rules is sufficient to increase confidence that the user is the person who entered the UID. The second set of rules is applied in parallel to other operations of method 200 once the user opts to use online payment service 120 with the financial institution. The second set of rules is verified prior to sending the one-time pin in operation 260. In this way, any latency from rule application is transparent to the user. In such embodiments, if the first or second set of rules are not satisfied, method 200 will proceed to operation 245.

In 240, ID verifier 112 sends online payment service 120 a response to the UID. The response to the UID is an indication that the user has one or more accounts that may be used to complete the payment transaction. In some embodiments, the financial institution sends the response using ID verifier 112 so that the online payment service 120 knows whether the financial institution is a candidate for providing payment to complete the user's transaction (e.g., checkout at online merchant 125 through online payment service 120).

In 245, method 200 does nothing. In embodiments where the UID does not match any user in the account information of user database 114, the financial institution has determined that none of its users is the user (e.g., the first user) of user device 130A. In such embodiments, the financial institution does not need to respond, as the user of user device 130A cannot complete a transaction via that financial institution, as the user does not have an account under the provided UID. In embodiments where the set of rules are not sufficiently satisfied, the financial institution has determined that there is insufficient confidence that the first user is the second user. In such embodiments, the financial institution does not respond because it is unwilling to provide payment services or information to the first user. In that case, online payment service 120 or the financial institution may ask the user to authenticate herself in another way, such as by entering a password, pin, or biometric information.

In 250, method 200 includes selecting the financial institution for use in the online payment service 120. In some embodiments, online payment service 120 selects the financial institution. In some embodiments, the user selects a single financial institution from a list provided by online payment service 120 using user device 130A. In some embodiments, online payment service 120 selects the single financial institution from among a group of one or more financial institutions and presents the single financial institution to the user for confirmation that the user wishes to proceed with the transaction using the single financial institution. In some embodiments, selecting the single financial institution also selects that the user opts into using a payment service of online payment service 120 and consents to receive a one-time pin in a message (e.g., an SMS message).

As discussed above, in some embodiments, online payment service 120 sends, in operation 210, the UID to more than one financial services provider. In some embodiments, online payment service 120 may then accept, in operation 250, a single financial services provider as a responder. In such embodiments, online payment service 120 only presents the single financial services provider as an option for selection. In some embodiments, the single financial services provider is selected based on the speed with which the financial services provider responded or a contractual agreement between the financial services provider and the online payment service 120.

In embodiments where the user the user selects the single financial institution, online payment service 120 responds to financial services backend 110 with a message that the user selected the financial institution.

In 255, method 200 includes receiving the selection of the financial institution (e.g., the single financial institution) from the online payment service 120.

In some embodiments, financial services backend 110 receives the message that user selected the financial institution.

In 260, method 200 includes sending user device 130B a one-time pin. The one-time pin is further described above with respect to FIG. 1. Financial services backend 110 sends the one-time pin to user device 130B. The one-time pin may be sent in an SMS message. In some embodiments, the SMS message automatically populates a pin entry form on the website for online payment service 120.

In some embodiments, financial services backend 110 performs operation 260 entirely on financial institution side 106. Financial services backend 110 generates the one-time pin and send the one-time pin to user device 130B. For example, ID verifier 112 generates the one-time pin and sends it to user device 130B.

In some embodiments, operation 260 is performed in part by financial services backend 110 on financial institution side 106 and in part by online payment service 120. Online payment service 120 generates the one-time pin and sends it to financial services backend 110. Financial services backend 110 then sends the one-time pin to user device 130B. In some embodiments, online payment service 120 cannot send user device 130B the one-time pin because online payment service 120 does not have access to contact information (e.g., mobile phone number) for user device 130B. In some embodiments, the account information in user database 114 does not include permission to allow third parties, such as online payment service 120, to contact user device 130B. As a result, online payment service 120 passes the one-time pin through financial services backend 110 to user device 130B.

In 265, method 200 includes entering the one-time pin into online payment service 120. In some embodiments, the user enters the one-time pin into a pin entry field in the website provided by online payment service 120.

In some embodiments, user device 130A through which the user is accessing online payment service 120 is also user device 130B (e.g., it is user device 130, as described above). In some embodiments, user device 130 receives the one-time pin in an SMS message that automatically fills in the pin entry field in the website provided by online payment service 120. In some embodiments, the user enters the one-time pin manually into the pin entry field via user device 130.

In some embodiments, the user accesses online payment service 120 via user device 130A that is different from user device 130B. When user device 130B receives the one-time pin, the user manually enters the pin into the pin entry field via user device 130A.

In 270, method 200 includes determining whether a pin input entered in the online payment service matches the one-time pin. Financial services backend 110 determines whether the pin input matches the one-time pin.

In some embodiments, financial services backend 110 receives the pin input in operation 265. Financial services backend 110 then compares the pin input to the one-time pin that financial services backend 110 sent to user device 130B. When the pin input matches the one-time pin, method 200 proceeds to operation 275. When the pin input does not match the one-time pin, method 200 terminates, as the user of user device 130A has incorrectly input the pin.

In some embodiments, financial services backend 110 receives a notification from online payment service 120 that the pin input matches the one-time pin. In such embodiments, online payment service 120 performs the comparison of the pin input to the one-time pin. When the pin input matches the one-time pin, online payment service 120 send the notification to financial services backend and then method 200 proceeds to operation 275. When the pin input does not match the one-time pin, method 200 terminates, as the user of user device 130A has incorrectly input the pin.

In 275, method 200 includes sending the online payment service 120 account identifier(s) for the user. ID Verifier 112 sends the account identifiers.

In some embodiments, the account identifiers are information that is associated with accounts of the user with the UID in the user database 114. The account identifiers are part or all of virtual account numbers assigned to the user accounts. The virtual account numbers are as discussed above with respect to FIG. 1. The account identifiers include account information sufficient for the user to determine which account is associated with the account information. ID verifier 112 sends account identifiers for one or more accounts associated with the UID.

For example, the account identifiers may include any or all of an image of a card style for the account, the last four numbers in the account number, the user's name, and the virtual account number.

In some embodiments, ID verifier 112 sends account identifiers for each account that satisfies the set of rules. For example, a user has four accounts that match the UID and ID verifier 112 subjects each account to operations 230 and 235. Three of the accounts satisfy the set of rules, so ID verifier 112 sends account identifiers for those three accounts in operation 240. Method 200 ignores the fourth account.

In some embodiments, a user has a single account that can be used to complete the transaction. The user does not need to select an account because the selection of the single financial institution selects the account. In such embodiments, operation 275 is skipped and method 200 proceeds to operation 290, skipping operations 280 and 285 as well.

In 80, method 200 includes selecting an account in the online payment service 120. The user selects the account from the website provided by online payment service 120 using user device 130A.

In some embodiments, the user selects an account from among the account identifiers sent by ID verifier 112 to online payment service 120. Online payment service 120 may present the user with one or more options of accounts that the user may use for the payment transaction. Online payment service 120 sends the account identifier for the account selected by the user back to the financial services backend 110.

In 285, method 200 includes receiving a selected account identifier from the online payment service 120. The financial services backend 110 receives the selected account identifier.

In some embodiments, where a user only has a single account that satisfies the set of rules, operations 275 and 280 treats the single account as the selected account. In some embodiments, operations 275, 280, and 285 are optional or are reduced to handshake messaging exchange between financial services backend 110 and online payment service 120 to allow method 200 to proceed to operation 290.

In 290, method 200 includes sending online payment service 120 account information corresponding to the selected account identifier. Financial services backend 110 sends the account information from user database 114 to online payment service 120. The account information may include a virtual account number that represents the selected account identifier, the user name, the user address, the user account CVV, and the expiration date of a card associated with the account. In some embodiments, financial services backend 110 sends the account information in a format that automatically populates an account information form in the website provided by online payment service 120.

In some embodiments, the financial services backend 110 updates user database 114 to include the virtual account number and the online payment service 120 associated with the virtual account number. In some embodiments, the virtual account number is selected to be different from a different virtual account number that represents a different online payment service 120.

In some embodiments, the virtual account number is also associated with online merchant 125 and the financial services backend 110 updates user database 114 to include online merchant 125 associated with the virtual account number. In some embodiments, the virtual account number is selected to be different from a different virtual account number that represents a different online payment service 120 and online merchant 125.

In 295, method 200 includes completing the payment transaction through online payment service 120 using the account information. Online payment service 120 completes the transaction and transfer payment from the financial institution to online merchant 125 using the account information.

In some embodiments, online payment service 120 stores some or all of the account information received from financial services backend 110. In some embodiments, the account information is stored for further use when the user attempts to make a payment transaction through online payment service 120.

In some embodiments, method 200 allows a user to use online payment to make a purchase from online merchant 125 with layered security and fraud protection while only entering a single UID and one-time pin. The user does not have to memorize the pin, as it is only used a single time. In some embodiments, the verification using the set of rules and the UID combined with the one-time pin allow a user to receive layered security that is effectively two-factor authentication.

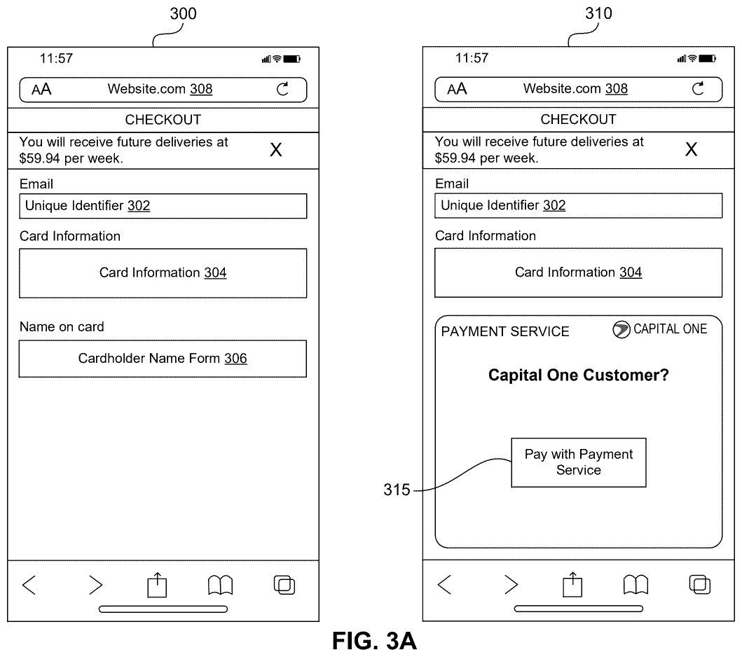

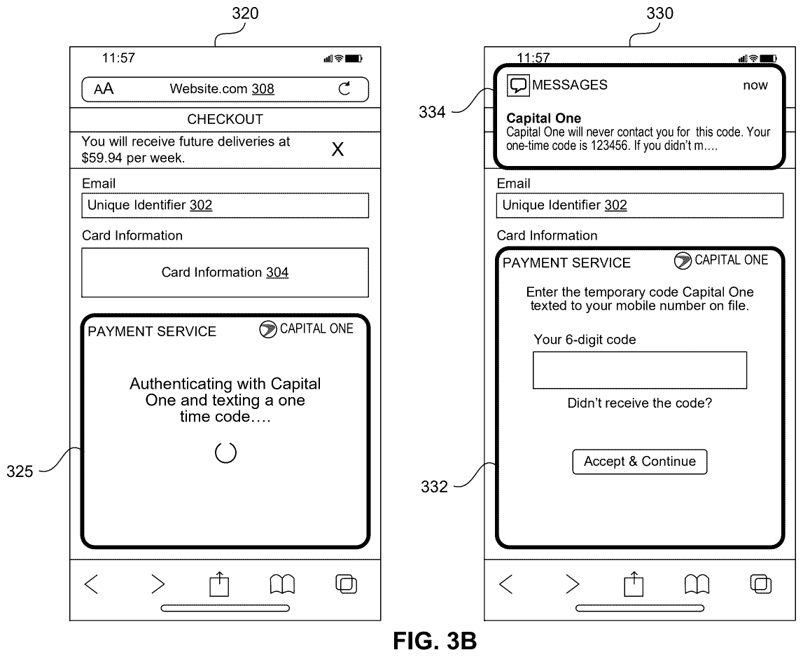

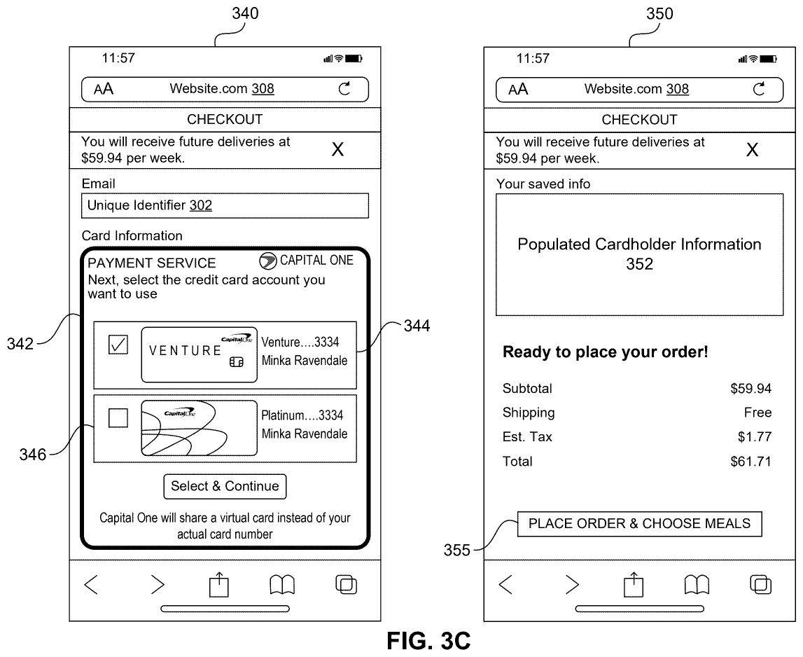

FIGS. 3A, 3B, and 3C illustrate example depictions of a device screen at various points in the methods described herein, according to some embodiments. These include payment entry screen 300, financial institution selection screen 310, loading screen 320, pin entry screen 330, account selection screen 340, and checkout completion screen 350, all of which are displayed on user device 130A. The specific configuration and appearance of the different screens is only exemplary of one possible embodiment of the systems and methods described herein and should not be considered to be limiting.

FIG. 3A illustrates payment entry screen 300 where a user begins a payment transaction for online merchant 125 via online payment service 120.

Payment entry screen 300 depicts a website 308 for checkout. Website 308 is the website provided by online payment service 120. Website 308 has entry fields for unique identifier 302 and card information 304, as well as cardholder name form 306. The user enters the UID into unique identifier 302. The entry field for card information 304 has entry fields for various account information, such as card or account number, CVV, expiration date, and address. Cardholder name form 306 has an entry field for the cardholder's or account holder's name.

While the user may, in some embodiments of online payment service 120, enter the various information required to make a payment into the entry fields, the methods and systems described herein allow the user to only enter the UID into unique identifier 302 (e.g., operation 210) and then use the low-friction layered authentication methods and systems described herein.

FIG. 3A also illustrates financial institution selection screen 310. Financial institution selection screen 310 has website 308 for online payment service 120 that has, in response to the user entering the UID in unique identifier 302, received a message from a financial institution (e.g., via operation 240) and the financial institution has been selected as the single financial institution (e.g., operation 245). Website 308 still has unique identifier 302 containing the UID and card information 304 with nothing in the entry field. A popup, which includes financial institution selection interface 315, covers the cardholder name form 306 from payment entry screen 300. The user selects the single financial institution by activating the button in financial institution selection interface 315. By selecting the single financial institution, the user also opts into using a payment service of online payment service 120 and consents to receive the one-time pin in a message (e.g., an SMS message).

FIG. 3B illustrates loading screen 320. As in financial institution selection screen 310, website 308 has unique identifier 302 containing the UID and card information 304 with nothing in the entry field. The popup, which has been updated or replaced based on the user's activation of financial institution selection interface 315, covers the cardholder name form 306 from payment entry screen 300. The popup now contains financial institution loading indicator 325, which displays while financial services backend processes and sends out the one-time pin (e.g., operations 255 and 260).

FIG. 3B also illustrates pin entry screen 330. Website 308 still has unique identifier 302 containing the UID. A new popup, pin entry interface 332, covers the entry fields for card information 304 and cardholder name form 306. SMS message receipt popup 334 also partially covers website 308. SMS message receipt popup 334 is a standard SMS message popup configured and displayed based on the messaging system being used on user device 130B. Here, because the SMS is received (e.g., in response to operation 260) on the user device 130A, user device 130A and user device 130B are user device 130. In some embodiments, user device 130A is separate from user device 130B and SMS message receipt popup 334 is not displayed, as it is received on a separate device.

Pin entry interface 332 has an entry field for the one-time pin (e.g., for completing operation 270), which is contained in the SMS message indicated by SMS message receipt popup 334. In some embodiments, user device 130 automatically populates the entry field with the one-time pin in response to receiving the SMS message. In some embodiments, automatically populating the one-time pin into pin entry interface 332 further reduces friction experienced by the user.

FIG. 3C illustrates account selection screen 340. Website 308 still has unique identifier 302 containing the UID. Account selection interface 342 covers the entry fields for card information 304 and cardholder name form 306. Account selection interface 342 may display accounts that are selectable (e.g., for completing operation 250), such as selected account 344 and unselected account 346. Initially, each account that a user may select is displayed with an unselected checkbox, such as the one displayed in unselected account 346. Once the user selects an account, the box becomes checked, such as the one displayed in selected account 344. In some embodiments, the user selects a single account.

FIG. 3C also illustrates checkout completion screen 350. In checkout compilation screen 350, website 308 has loaded or updated the page for checkout completion (e.g., operation 280). Checkout completion screen 350 loads when the layered authentication is complete, the user has selected an account, and financial services backend 110 has provided the account information for payment to the online payment service 120. In the page loaded in website 308 for checkout completion, cardholder information 304 has received account information from financial services backend 110. The completed cardholder information is now populated cardholder information 352.

Populated cardholder information 352 includes sufficient account information to complete the payment transaction, such as a card or account number (e.g., the virtual account number), user name, CVV, expiration date, and user address. The populated cardholder information may be automatically input to reduce user friction, as described above.

Website 308 also has a confirm payment interface 355. Confirm payment interface 355 may be a button or other interface to allow the user to select to complete the payment transaction.

FIG. 4 depicts an example computer system 400 useful for implementing various embodiments.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1-20. (canceled)

21. A method, comprising:
receiving transaction data comprising a unique identifier and device characteristics of a user device, the transaction data provided to a merchant during an online transaction;
correlating the unique identifier to a primary account number (“PAN”) associated with a user account by:
determining that the unique identifier corresponds to identification information associated with the user account; and
verifying that the device characteristics of the user device correspond to the identification information;
transmitting an electronic verification message comprising a one-time pin to the user device;
receiving an electronic response message indicating that the user device entered a pin input matching the one-time pin;
transmitting a virtual card number obfuscating the PAN, wherein the virtual card number is a proxy of the PAN; and
initiating a transfer of funds from the user account to the merchant using the virtual card number.

22. The method of claim 21, further comprising:
sending one or more account identifiers for the user account to the user device; and
receiving a selection of an account identifier from the one or more account identifiers by the user device,
wherein the selection of the account identifier corresponds to the unique identifier in the transaction data.

23. The method of claim 21, wherein the verifying the device characteristics further comprises:
determining that geolocation data of the user device corresponds to the user account by executing a real-time comparison between a stored location associated with the user account and a transmitted location of the user device; and
determining that a device identifier of the user device matches a stored device identifier of the user account,
wherein the transmitted location and the device identifier are included in the device characteristics of the transaction data.

24. The method of claim 21, wherein the determining the unique identifier corresponds to the identification information further comprises:
identifying that the identification information comprises at least one of: (i) an enablement identifier specifying the user account is enabled for online payment, (ii) an amount sufficient to pay for the transaction, (iii) a fraud risk identifier, (iv) a one-time pin identifier indicating the user device is enabled to receive the one-time pin, and (v) a consent identifier specifying the user account has consented to third-party data sharing.

25. The method of claim 21, further comprising:
updating a user database to associate the virtual card number with an online payment service; and
based on the updating, transmitting, by the server, the virtual card number to the online payment service upon receiving subsequent transaction data corresponding to a subsequent online transaction.

26. The method of claim 21, wherein the transmitting the electronic verification message further comprises:
generating a display instruction to the user device to automatically populate the one-time pin into a field of a website associated with the merchant; and
based on the display instruction, causing the user device to populate the field of the website with the one-time pin.

27. The computer-implemented method of claim 21, further comprising:
depositing the virtual card number in a virtual wallet corresponding to the user account; and
transmitting the funds to the merchant using the virtual wallet.

28. A system comprising:
a memory; and
at least one processor coupled to the memory and configured to:
receive transaction data comprising a unique identifier and device characteristics of a user device, the transaction data provided to a merchant during an online transaction;
correlate the unique identifier to a primary account number (“PAN”) associated with a user account by:
determining that the unique identifier corresponds to identification information associated with the user account; and
verifying that the device characteristics of the user device correspond to the identification information;
transmit an electronic verification message comprising a one-time pin to the user device;
receive an electronic response message indicating that the user device entered a pin input matching the one-time pin;
transmit a virtual card number obfuscating the PAN, wherein the virtual card number is a proxy of the PAN; and
initiate a transfer of funds from the user account to the merchant using the virtual card number.

29. The system of claim 28, the at least one processor further configured to:
send one or more account identifiers for the user account to the user device; and
receive a selection of an account identifier from the one or more account identifiers by the user device,
wherein the selection of the account identifier corresponds to the unique identifier in the transaction data.

30. The system of claim 28, wherein to verify the device characteristics, the at least one processor is further configured to:
determine that geolocation data of the user device corresponds to the user account by executing a real-time comparison between a stored location associated with the user account and a transmitted location of the user device; and
determine that a device identifier of the user device matches a stored device identifier of the user account,
wherein the transmitted location and the device identifier are included in the device characteristics of the transaction data.

31. The system of claim 28, wherein to determine that the unique identifier corresponds to the identification information, the at least one processor is further configured to:
identify that the identification information comprises at least one of: (i) an enablement identifier specifying the user account is enabled for online payment, (ii) an amount sufficient to pay for the transaction, (iii) a fraud risk identifier, (iv) a one-time pin identifier indicating the user device is enabled to receive the one-time pin, and (v) a consent identifier specifying the user account has consented to third-party data sharing.

32. The system of claim 28, the at least one processor further configured to:
update a user database to associate the virtual card number with the online payment service; and
based on the updating, transmit the virtual card number to the online payment service upon receiving subsequent transaction data corresponding to a subsequent online transaction.

33. The system of claim 28, wherein to transmit the electronic verification message, the at least one processor is further configured to:
generate a display instruction to the user device to automatically populate the one-time pin into a field of a website associated with the merchant; and
based on the display instruction, cause the user device to populate the field of the website with the one-time pin.

34. The system of claim 28, the at least one processor further configured to:
deposit the virtual card number in a virtual wallet corresponding to the user account, wherein the virtual wallet is maintained by the online payment service; and
transmit the funds to the merchant using the virtual wallet.

35. A non-transitory computer-readable device having instructions stored thereon that, when executed by at least one computing device, cause the at least one computing device to perform operations, the operations comprising:
receiving transaction data comprising a unique identifier and device characteristics of a user device, the transaction data provided to a merchant during an online transaction;
correlating the unique identifier to a primary account number (“PAN”) associated with a user account by:
determining that the unique identifier corresponds to identification information associated with the user account; and
verifying that the device characteristics of the user device correspond to the identification information;
transmitting an electronic verification message comprising a one-time pin to the user device;
receiving an electronic response message indicating that the user device entered a pin input matching the one-time pin;
transmitting a virtual card number obfuscating the PAN, wherein the virtual card number is a proxy of the PAN; and
initiating a transfer of funds from the user account to the merchant using the virtual card number.

36. The non-transitory computer-readable device of claim 35, the operations further comprising:
sending one or more account identifiers for the user account to the user device; and
receiving a selection of an account identifier from the one or more account identifiers by the user device,
wherein the selection of the account identifier corresponds to the unique identifier in the transaction data.

37. The non-transitory computer-readable device of claim 35, wherein the verifying the device characteristics further comprises:
determining that geolocation data of the user device corresponds to the user account by executing a real-time comparison between a stored location associated with the user account and a transmitted location of the user device; and
determining that a device identifier of the user device matches a stored device identifier of the user account,
wherein the transmitted location and the device identifier are included in the device characteristics of the transaction data.

38. The non-transitory computer-readable device of claim 35, wherein the determining the unique identifier corresponds to the identification information further comprises:
identifying that the identification information comprises at least one of: (i) an enablement identifier specifying the user account is enabled for online payment, (ii) an amount sufficient to pay for the transaction, (iii) a fraud risk identifier, (iv) a one-time pin identifier indicating the user device is enabled to receive the one-time pin, and (v) a consent identifier specifying the user account has consented to third-party data sharing.

39. The non-transitory computer-readable device of claim 35, the operations further comprising:
updating a user database to associate the virtual card number with an online payment service; and
based on the updating, transmitting the virtual card number to the online payment service upon receiving subsequent transaction data corresponding to a subsequent online transaction.

40. The non-transitory computer-readable device of claim 35, wherein the transmitting the electronic verification message further comprises:
generating a display instruction to the user device to automatically populate the one-time pin into a field of a website associated with the merchant; and
based on the display instruction, causing the user device to populate the field of the website with the one-time pin.
